(19) United States
(12) Patent Application Publication
(10) Pub. No.: US 2003/0136874 A1
(43) Pub. Date: Jul. 24, 2003

(54) Method for safer mid-air refueling

(76) Inventor: David Michael Gjerdrum, Palo Alto, CA (US)

Correspondence Address: David M. Gjerdrum, 559 Barron Avenue, Palo Alto, CA, 94306-2704, US

(21) Appl. No.: 10/316,623

(22) Filed: Dec. 10, 2002

Related U.S. Application Data
(60) Provisional application No. 60/337,743, filed on Dec. 10, 2001.

(51) Int. Cl. B64C 27/22

(52) U.S. Cl. 244/10

(57) ABSTRACT

This invention teaches a method for delivering fuel to flying helicopter and fixed winged aircraft that is both safer than and compatible with presently used ‘boom’ and ‘drogue’ airborne fueling systems. This method introduces to the mid-air refueling repertoire the use of refueling drones as additional air vehicles, in a first instance tethered to and deployed from the craft receiving fuel. The recipient drone fuselage, configured with a receptacle for accommodating a tanker-controlled fuel dispensing boom, a forward-facing recipient-controlled fuel capture probe for accommodating fuel dispensing drogues, or both, assures compatibility with all mid-air fuel dispensing equipment in present use. The same invention in a later instance extends the inventory of mid-air fuel dispensing resources to include fueling drones of complementary configuration for deployment from airborne fuel tankers. Although towed by its deploying aircraft, a given drone may have locally available thrust capability to improve flight control and orientation during fueling and other operations. In any instance, the deployment tether acts as an umbilical in providing a path for fuel transfer and data lines, and contemporary guidance technology may be used to control the drone's flight. Such technology includes real-time inertial and positional sensor data for the drone, the tanker and the recipient aircraft, as exchanged among the aircraft. Said data may be computationally integrated through a Kalman Filter or similar algorithm driving the drone's control system, thereby assuring reliable docking and fuel exchange with minimal operator intervention. Since the present application domain is prominently military, mid-air refueling operations quiet in the radio spectrum are preferred, favoring embodiments in which the energy emitting portions of the position sensing and data exchange systems are limited to the optical spectrum. This invention improves the safety and reliability of mid-air refueling in several particulars. The use of tethered drones in the mid-air refueling process allows a substantial increase in the separation between tanker and receiving aircraft, thereby lowering the risk of mid-air collision. To the extent that such separation is vertical or lateral with respect to the common line of flight, there is a corresponding reduced risk of the tanker's wake disturbing the flight path of the receiving aircraft. Since the drone acts much as does a

This utility patent filing proceeds from Provisional Filing “OC00000006330199” [Application No. 60/337,743, filed Dec. 10, 2001, as confirmed (Confirmation No. 2296) on Jan. 3, 2002]. The disclosure and patent description contained herein seek further to explicate and perfect this invention

### BACKGROUND OF THE INVENTION

1. Field of the Invention

The field of this invention pertains to means for transferring fuel between and among airborne vehicles, specifying designs and methods enhancing the safety of such operations.

2. Description of Prior Art

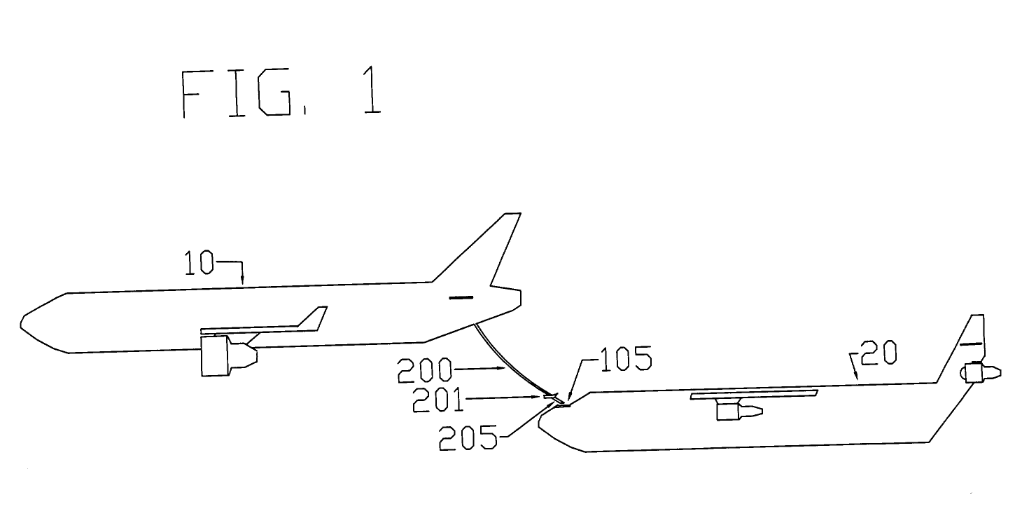

Prior art in the current field of mid-air refueling and the context of the present invention may best be understood in reference to the first two drawings included in this application. FIG. 1 depicts the refueling method known as ‘boom and receptacle’ fuel exchange, whereby a tanker aircraft 10 provides fuel to a receiving aircraft 20 by means of a fueling boom 200. In such a configuration, a boom operator in the aft section of tanker 10 controls the position of fueling boom 200, both by motor control of its extended length and by means of ruddervator 201 used to manage the orientation of the fuel boom assembly in the turbulent air stream produced by tanker 10, so as to allow the fueling ‘nozzle’ 205 to seat properly into receptacle 105 aboard receiving aircraft 20. In such operations, receiving aircraft 20 typically maintains minimal variance from straight and level flight at a fixed distance from tanker 10, and the joining of the two aircraft is under control of the fueling operator. Since a single fueling operator aboard tanker 10 is active in managing the ‘docking’ of the refueling boom assembly with the receptacle 105, only one aircraft may be refueled by this method at a given time, although typically at a high flow rate (c. 240 gallons per minute). In normal practice, such refueling is limited to fueling fighters as well bombers and other heavy transport craft, in no small part because the operation flight path places the receiving aircraft 20 directly in the turbulent fuselage ‘wake’ of the supplying tanker 10.

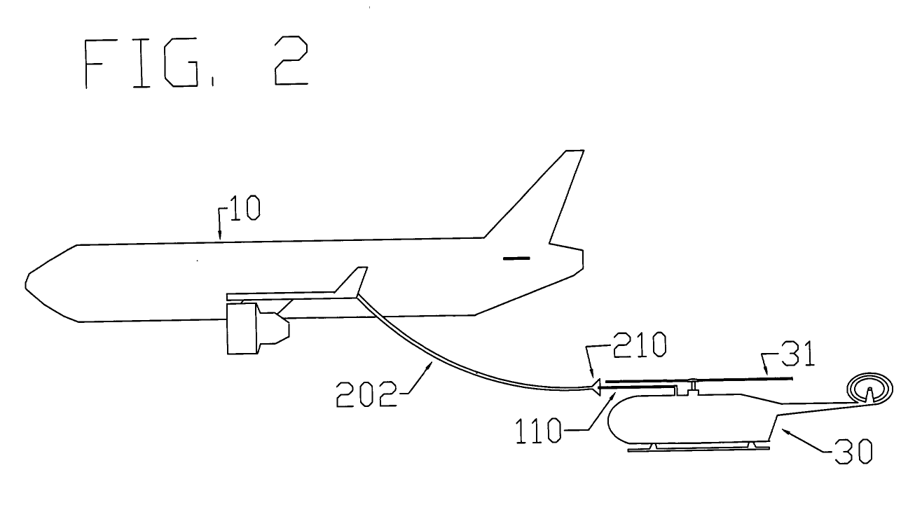

FIG. 2 depicts the refueling method known as ‘drogue and probe’ fuel exchange, whereby a tanker aircraft 10 provides fuel to a receiving aircraft 30, by means of a conduit 202, deployed at the source side (typically as depicted via the wing) from said tanker 10, presenting fuel on the receiving side to aircraft 30 via drogue 210. Receiving aircraft 30 in turn attaches to drogue 210 by means of a probe 110. Normal practice in such fueling operations is for tanker 10 to maintain minimal variance from straight and level flight throughout the operation, with control of the ‘docking’ operation largely in the hands of the receiving aircraft's pilot. This modality of mid-air refueling allows for the deployment of more than one drogue, and thereby the simultaneous fueling of more than one aircraft, typically at lower fuel flow rates (c. 40 gallons per minute). While the ‘drogue and probe’ method can fuel aircraft with lower performance characteristics than those of fighter jets and heavy aircraft associated with ‘boom and receptacle’ refueling, turbulence from the wing of its tanker 10 still contributes to the complexity of the needed flight maneuvers.

The receiving aircraft 30 depicted is a helicopter, wherein probe 210 is located beneath and parallel to rotor 31. Current ‘boom and receptacle’ technology as described above cannot deliver fuel to a helicopter due to the geometry of helicopter rotor 31 with respect to the helicopter body. ‘Drogue and probe’ is the sole method presently used for mid-air refueling of helicopters. Due to the risks inherent to the close proximity of probe 210 to rotor 31, such use is restricted to ‘special operations’ and is not part of normal helicopter training. The lack of such general training in turn lowers pilot experience and adds risk to mission critical ‘special operations’ that do demand mid-air helicopter refueling.

### REFERENCES

The text to follow reflects research to date or prior art and other information material to the present invention.

Press Release.

The following press release supports the characterization of the present state of the art of Mid-Air refueling represented above.

Polish airmen learn air refueling techniques at RAF Mildenhall

Released: Aug. 2, 2000

By Karen Abeyasekere

100th Air Refueling Wing Public Affairs

ROYAL AIR FORCE MILDENHALL, England (USAFENS)—Three members of the Polish Air and Air Defense Forces came here on a one-week tour to learn about air refueling techniques.

The PAADF is made up of three components—air defense, electronic warfare and air forces—and representatives from each of the three areas met with members of the 100th Air Refueling Wing July 7-14 to familiarizing themselves with the history, technical process, planning and employment of air-to-air refueling.

Poland does not currently have the ability to refuel its aircraft in midair. Because of its air refueling mission, RAF Mildenhall was selected as the site for the familiarization tour.

The Air Force performs mainly boom air refueling while the rest of NATO performs probe and drogue refueling, said Capt. Lou Lombardi, 100th ARW Joint Contact Team program manager.

“We wanted to show them both types of refueling and provide them the information to make an informed choice,” said Lombardi. “Since they are new to NATO, we are showing them Air Force procedures and at the same time emphasizing NATO procedures.”

Lt. Col. Slawomir Dygnatowski, chief of the operations division, Air Component, PAADF, said his military currently does not have any air refuelable aircraft, but it is considering the purchase of either F-16s, F-18s, Mirage 2005 (French) or Grippens (Swedish).

The F-16 is boom refueled and the others are probe and drogue, like helicopters from the 352nd Special Operations Group here.

The team was given the opportunity to learn about both types of air refueling techniques. They can decide which is best for them, explained Lombardi.

“We had a chance to see all the procedures for air refueling fighters and helicopters,” said Col. Stanislaw Targosz, Chief of Air Component, PAADF. “We have a much better understanding of them now.”

Poland joined NATO in March 1999 and is currently working towards achieving NATO interoperability by purchasing new military equipment or updating its current inventory.

### PATENT ABSTRACTS OF PRIOR ART

As recited below, patent abstracts of prior art for each of the present refueling methods described above are included with this application. Additional patent abstracts, pertaining to lighting, navigation, and the mid-air refueling of drone aircraft are also included

The following abstracts from US PTO searches appear relevant to assessing prior art with respect to this invention.

[Boom and Receptacle]

Weiland (1978, U.S. Pat. No. 4,872,284, Aerial refueling boom articulation, assigned to the Boeing Company), describes “a flying refueling boom for an aerial tanker airplane, with a mechanism for moving the boom about different axes. The boom having a pair of aerodynamic surfaces formed into a Vee and known as ruddevators, for moving the boom about the following axes: a tiltable vertical axis for boom movement in a sideways direction or in azimuth; a lateral axis for boom movement in an up-and-down direction or in elevation; and a longitudinal axis for movement of the boom about a roll axis. The ruddevator control system includes a pantographing cable system for automatically changing the angle-of-attack of the aerodynamic surfaces and for alleviating air loads imposed by the receiver airplane, when it is imparting the movement of the boom during refueling engagement. The boom support system includes an articulation mechanism for combining a certain amount of boom roll motion as a function of azimuth movement of the boom; and a device for varying the ratio between the degree of roll motion change vs. the degree of azimuth change. The boom articulation mechanism accomplishes this without revising the existing pantographing system in the KC-135 tanker airplane, or its structure and functions to optimize the existing configuration to obtain the desired operating refueling envelope. Further embodiments depict boom articulation mechanisms for combining a predetermined amount of boom roll motion with sideward movement of the boom, while the tanker airplane is airborne, and thereby adapt the boom operating envelope to the different flight conditions of various types of receiver airplanes.”

Robinson (1978, U.S. Pat. No. 4,129,270, Air refueling boom pivot gimbal arrangements, assigned to the Boeing Company), describes “an aerial refueling boom utilized in the transfer of fuel from a tanker airplane to a receiver airplane and more particularly, to the boom geometry or gimballing which comprises an axis fixed with respect to structure of the tanker airplane about which the boom rotates in elevation and an inclinable axis about which the boom rotates for lateral movement. The angle of inclination of the boom lateral motion pivot axis or azimuth axis varies with respect to the longitudinal axis of the airplane axis as the boom is changed in elevation angle. A pair of aerodynamic surfaces formed into a Vee and known as ruddevators are mounted towards the trailing end of the boom for flying the boom about these axes. The ruddevators are part of a control system which includes a pantographing cable system for automatically changing the angle-of-attack of the aerodynamic surfaces and for alleviating the air loads imposed by the receiver airplane when it is imparting the movement of the boom during the refueling engagement. The boom support system includes articulation which provides for combining a certain amount of boom rolling action with sideward movement of the boom and varies the ratio between the degree of roll motion vs. the degree of azimuth, as the boom is raised and lowered during changes in elevational angles while operating within the normal ranges of the refueling disconnect envelope.”

Higgs, et al. (1999, U.S. Pat. No. 5,996,939, Aerial refueling boom with translating pivot, assigned to the Boeing Company), describes “an aerial refueling system includes a pod assembly which is removably mounted for translation on an elongated pylon secured to the underside of an aircraft fuselage, whereby the pod assembly is moved relatively forward on the fuselage for stowage and relatively aftward on the fuselage for refueling operations. The pod assembly includes a pivotable, telescoping boom having control surfaces by which to aerodynamically position the boom's free end relative to the pod assembly. A coupling preferably establishes fluid communication between the boom and a fuel tank within the aircraft fuselage only when the pod assembly assumes the relatively-aftward refueling position on the pylon. A ram-air turbine on the forward end of the pod assembly provides all necessary power for the pod assembly, with wireless remote operation of all pod assembly functions preferably used to minimize the extent of alterations when installing the aerial refueling system on the aircraft.”

Weiland (1978), Robinson (1978) and Higgs, et al (1999) each stand as exemplars of ongoing efforts to improve the safety, art and utility of “boom and receptacle” mid-air refueling technology. A utility each of the exemplars provides is that of decoupling the aircraft receiving fuel from certain complexities in managing its flight profile in face of airstream perturbations induced by the presence and “wake” of the heavy tanker providing fuel. In the above instances, such utility pertains to enhancing the articulation of control surfaces on the boom assembly in order better to match the dynamic flight attitude and profile of the receiving aircraft as its mass and center of gravity change due to the fuel received.

The present invention, by introducing an intermediate drone tethered to the receiving aircraft, provides a corresponding utility in at least two aspects. Firstly, since the drone, operating within the tanker's wake as a ‘fuel filter’ rather than as a long-term fuel storage receptacle, maintains a relatively “steady-state” mass and center of gravity through the fueling operation, the need for the drone to change flight attitude during the fueling process is minimized. Secondly, as fuel mass transfers to it from the drone, the receiving aircraft can change its flight attitude outside the airstream perturbed by the tanker's wake.

[Center of Gravity Monitoring]

Adelson, et al. (1986, U.S. Pat. No. 4,622,639, Aircraft center of gravity and fuel level advisory system, assigned to The Boeing Company) describes “an aircraft center of gravity and fuel level advisory system connected to the aircraft's fuel tank gauges and operated by an aircraft personnel. The system provides the aircraft's personnel with real time display of the aircraft's center of gravity and a signal when forward and aft center of gravity limits are approached. The system provides a means for a crew member to select a fuel level for a tank or set of tanks and when the actual fuel level approaches the selected value, the system will alert the crew member.”

The above invention, incorporating as it does means to monitor the effect of mid-air refueling on the receiving aircraft's center of gravity and thereby flight attitude, serves to support the contention offered in this patent application that such changes in mass and attitude contribute to the complexity of maintaining an appropriate flight profile within the wake of a heavy tanker, a problem mediated by the refueling drone this invention adds to the mid-air refueling repertoire.

[Drogue and Probe]

Greenhalgh (1999, U.S. Pat. No. 5,921,294, Air refueling drogue, assigned to The United States of America as represented by the Secretary of the Navy) describes “an apparatus attached to a fuel hose and deployed rearwardly of a tanker craft, the apparatus for inflight refueling of an aircraft and includes a fuel valve for controlling the flow of fuel through the valve, a coupler attached to the fuel valve for receiving and locking onto the probe of a receiving aircraft and for conveying fuel through the coupler and to the probe of the receiving aircraft and a plurality of struts attached to the coupler, the struts configured and arranged to compress inwardly when acted upon by sufficient compressive forces and to expand outwardly against aerodynamic forces when located in the airstream, the struts forming a bell shaped target for guiding the probe of the receiving aircraft into the coupler.”

Emerson, et al. (1990, U.S. Pat. No. 4,927,099, Aerodynamic controllably vented pressure modulating drogue, assigned to DeCel Incorporated) describes “an aeronautical drogue having a canopy and support members connecting the canopy to a connector provides for essentially constant drag at variable speeds by aerodynamic pressure modulation through controllably venting the canopy by constructing the canopy of a plurality of separate elastic bands positioned side by side the elastic bands being connected at spaced intervals by flexible connections.”

Perrella (1985, U.S. Pat. No. 4,540,144, Telescoping fuel probe, assigned to United Technologies Corporation) describes “the telescoping member of an aerial refueling probe is hydraulically actuated for extension/retraction by pressurized fuel. The force for extending the probe is the result of fuel pressure against a check valve in the end of the telescoping member. The force for retraction is the result of fuel pressure in a retraction chamber between the telescoping member and the inner fixed member of the probe wherein the separating force generated therein retracts the telescoping member. A housing is provided to isolate the probe from the environment and to reduce the frictional forces that resist the telescoping motion. A system for locking the telescoping member in its retracted position and in its extended position is also provided. The telescoping member and the housing may be composite graphite/epoxy.”

Ward (1996, U.S. Pat. No. 5,573,206, Hose and drogue boom refueling system, for aircraft, assigned to Able Corporation) describes “an aerial refueling system for refueling aircraft in flight from a tanker airplane, via a fuel supply hose and drogue system comprising an elongated boom having inboard and outboard end portions, and having pivotal support structure at the inboard end portion to accommodate pivoting of the boom between retracted position adjacent the airplane fuselage and extended position in which the boom projects away from the fuselage; the boom having a guide to guide endwise extension and retraction of the hose and drogue to and from aircraft refueling deployed position; and hose and drogue control structure carried by the aircraft fuselage for effecting storage, and- hose and drogue endwise extension and retraction via the guide.”

Mouskis, et al. (2000, U.S. Pat. No. 6,145,788, Drogue assembly for in-flight refueling, assigned to Flight Refueling Limited (Dorset, GB)) describes “a drogue assembly (10) for in flight refueling includes a circumferenal array of triangular support arms which carry a drogue parachute (29) which extends circumferentially around their shorter sides. Each support arm is pivoted and mounted on a pivot pin (19) at its apex for pivotal movement in a radial direction. At least alternate ones of the support arms carry leaf springs which extend into pockets (51) formed in the drogue parachute (29). The leaf springs act on the drogue parachute (29) in opposition to air pressure loading on it in flight so that it tends to increase the chord angle of the drogue parachute (29) from the leading edge. Hence the effective area of the drogue parachute in flight is varied automatically above a certain predetermined minimum which depends on the dimensions of the trailing edge so it is reduced as air speed is increased and vice versa.”

The above group of patents reflecting improvements in the “drogue and probe” mode of mid-air refueling, primarily with respect to more effective deployment and stabilization of the drogue in the context of the refueling process, across a range of flight conditions.

As with the prior group, the inventions cited above are seen as background to the present invention, forming an operational context for its usage rather than as its immediate precursors.

[Helicopter Tanker Boom]

Piasecki (1995, U.S. Pat. No. 5,393,015, Rotary wing aircraft in-flight refueling device, assigned to Piasecki Aircraft Corporation) describes “an elongated, rigid boom for the inflight refueling of rotary wing aircraft in which a forward end of the boom is adapted for attachment to the fuselage of a rotary wing tanker aircraft and is of sufficient length to extend rearwardly of the tanker aircraft for the rear end of the boom to be clear of the tanker aircraft rotor path. The forward end of a funnel refueling drogue configured to receive the fueling probe of an aircraft to be refueled is swivelly attached to the rear end of the rigid boom and a fuel line supported by the boom extends from a connection into the tanker aircraft refueling tanks to a female refueling aircraft probe connection in the drogue. Pressurized air flowing within the boom is discharged from a downwardly directed nozzle and selectively from outwardly facing nozzles on each side of the boom adjacent the boom rear end with the nozzles being configured to establish a volume rate discharge as creates a vertical lifting force on the boom compensating for gravity and rotor downwash and boom side forces selectively directed horizontally outwardly in either direction for establishing yaw control of the boom.”

The above invention, really an instance of the “drogue and probe” series discussed above, is noteworthy for suggesting a role for rotary wing aircraft in mid-air refueling. While the scenario of a helicopter as the receiving aircraft is not addressed by Piasecki (1995), the treatment found there does highlight the complicating factors a rotary wing aircraft brings to mid-air refueling, all of which are mitigated generally by the present invention.

[Tanker Pod]

Moss, et al. (1997, U.S. Pat. No. 5,667,170, Pod mounted refueling system, assigned to Tracor Flight Systems, Inc.) describes “a refueling system mounted to an aircraft fuselage for transferring fuel from a tanker aircraft to a receiver aircraft. The refueling system including a pylon extending from the fuselage at a position aft of the main wing and having a refueling pod mounted thereto at an outboard location. A refueling hose is disposed within and extendable from the refueling pod and functions to transfer fuel from the refueling pod to the receiver aircraft. A means for transferring fuel from a fuel source, located within the aircraft to the refueling hose is also provided. The pylon and refueling pod are configured so as to channel the refueling hose in a preferred direction to maximize safety during refueling. The channeling of the refueling hose is accomplished by mounting the refueling pod at an angle to the pylon, mounting the refueling pod at an angle to a horizontal plane, mounting the pylon at angle to the fuselage, or a combination of these mounting arrangements. The pylons are preferably supported by a sandwich-type reinforcement of the fuselage floor between the pylons.”

Moss, et al. (1997) is similar to the present invention in specifying a fuselage-external fuel container serving as a buffer between a tanker and a receiving aircraft, and distinct from the present invention in that the orientation of said container is in close proximity to the tanker's fuselage, as determined by pylons anchoring the container to the tanker. To the extent that pylon-based positioning serves to isolate the receiving aircraft from the tanker's wake, Moss, et al. (1997) and the present invention share a common utility. By such a metric the present invention can be view as the next step in a logical evolution toward the goal of wake-turbulence independent mid-air refueling.

[Lighting for the Mid-Air Refueling Interface]

Ruzicka (1999, U.S. Pat. No. 5,904,729, Automated director light system for aerial refueling operations, assigned to The Boeing Corporation) describes “a method and apparatus for generating visual information for an operator in a first aircraft and a pilot in a second aircraft regarding the second aircraft's position relative to a first aircraft. A 3-D camera system (72) generates a real time 3-D video image of the second aircraft. A selecting device (82) provides selection of a stored geometric model based on the second aircraft type. A display monitor (83) displays the generated real time 3-D video image and the selected geometric model. A matching device (84) matches the displayed geometric model to the displayed real time 3-D video image. A processor (84) determines the position of the second aircraft relative to stored zone information according to the matched geometric model and generates control signals according to the determined second aircraft position. Director lights (88) mounted on the outside of the first aircraft display position information visible to the pilot of the second aircraft according to the generated control signals. The monitor also displays the position of the second aircraft relative to a boom.”

Korski (1983, U.S. Pat. No. 4,380,788, Aerial refuel floodlight, assigned to The United States of America as represented by the Secretary of the Air) describes “an aerial refuel floodlight capable of being mounted on the leading edge of a vertical stabilizer in a receiver aircraft utilized for in flight refueling. The aerial refuel floodlight is of a projectile-shape having a lamp mounted therein. Surrounding the lamp is a cone-shaped reflecting element terminating in a hemispherically-shaped reflecting element which directs light emanating from said lamp through an off-axis lens mounted adjacent thereto. A scoop-shaped reflector situated adjacent the lens and in the upper part of the fixture directs the magnified light onto the fuselage of the receiver aircraft adjacent to and including the refuel receptacle. The location of the aerial refuel floodlight on the vertical stabilizer causes the refueling boom to cast a shadow on the fuselage of the aircraft being refueled to give the boom operator a means for estimating position and distance between the extended boom and the refuel receptacle while simultaneously eliminating substantial amounts of glare from the fuselage of the aircraft.”

Finsness, et al. (1981, U.S. Pat. No. 4,288,845, Aerial refueling receptacle floodlights-spoiler and fuselage, nose mounted, assigned to The United States of America as represented by the Secretary of the Air) describes “a floodlight illumination system, in structural combination with a fuel-receiving aircraft having an aerial refueling receptacle, that permits efficient and effective in-flight night refueling of the aircraft. The illumination system comprises: a selectively lightable, retractable aerodynamically shaped spoiler mounted on the nose of the aircraft which illuminates the top surface of the refueling receptacle, and, two similar (i.e., symmetrically shaped and dimensioned), selectively lightable fairings mounted on the port and starboard sides of the hose of the aircraft, parallel to airflow lines, with one fairing illuminating the port side surface of the refueling receptacle, and with the other fairing illuminating the starboard side surface of the refueling receptacle. The result is adequate and glare-free lighting of the refueling receptacle of the receiving aircraft, which, in turn, allows the operator of the refueling boom of the refueling aircraft to refuel the receiving aircraft without the loss of depth of perception, and without the glare, which ordinarily occur when a receiving aircraft is conventionally illuminated for in-flight night refueling.”

Crabere, et al. (1996, U.S. Pat. No. 5,499,784, Flight refuelling system, assigned to Aerospatiale Societe Nationale Industrielle (FR)), asserts, “The invention relates to a system for the flight refueling of at least one first aircraft provided with an intermediate fuel intake means connected to at least one fuel tank, by a second aircraft equipped with an intermediate fuel supply means connected to at least one fuel supply tank and which can be connected to the intermediate fuel intake means so as to permit, with the aid of at least one fuel pump, the transfer of fuel contained in the tank(s) of the second aircraft to the tank(s) of the first aircraft. This system includes at least one camera positioned below the aircraft, at least one multimode display to display at least one image from a camera and symbology information such as fuel data information used during the refueling operation. The system further includes multifunction equipment incorporating a screen for monitoring the refueling operation and a control keyboard to control several operations, in a single work station within the second aircraft for checking the flight refueling of the first aircraft.”

I cite the above inventions in main to emphasize the importance of assuring a valid interface between the tanker and receiving aircraft as a necessary preliminary to, and ongoing requirement for, effective and reliable fuel exchanges between aircraft. Not surprisingly, the systems discussed above hinge largely on enhancing the capacity for human decision makers to make the docking by visual means. While the present invention serves to reduce the risk of wake turbulence, it by design relies on and is compatible with means such as the above, as well as more advanced means such as those discussed below, to accomplish the fueling interface.

[UAV Refueling]

Eckstein (1999, U.S. Pat. No. 5,906,336, Method and apparatus for temporarily interconnecting an unmanned aerial vehicle) describes “an apparatus and method for aerial refueling of an unmanned aerial vehicle (UAV) wherein a laser receiver/transmitter on a target device towed by a host aircraft projects a reticle pattern aft of the host aircraft and a laser receiver/transmitter on a probe of the UAV is activated as the UAV is moved within the projected reticle pattern. Thereafter, a rangefinder guides the UAV towards the host aircraft until the laser transmitter/receiver of the UAV is aligned and boresighted with the laser transmitter/receiver of the host aircraft at which time the mode of the laser transmitter/receiver of the UAV alternates between a rangefinder mode and a modulation data link mode to transmit vital information concerning the UAV to the host aircraft. The probe on the UAV continues to move toward the drogue until the probe establishes contact within a receptacle structure of the drogue and is coupled thereto.”

Of all the prior art cited, Eckstein (1999), while distinct in function, is closest in embodiment to the present invention. Such an embodiment, enlarged to include an umbilical link to an aircraft receiving fuel, would form an appropriate prototype for the present invention. With respect to the above discussion, the specific use of range finding and laser mediated signaling called out, while clearly not the only method possible, stand as a useful exemplar for the type of inter-vehicle docking needed for this application.

[Inter-Aircraft Communications/Navigation:]

Fitzsimmons, et al. (1979, U.S. Pat. No. 4,170,773, Precision approach sensor system for aircraft, assigned to the Boeing Company) describes “a microwave interrogation-transponder system for controlling the airborne rendezvous and closure of two aircraft for aerial refueling and the like. The system of the invention includes a microwave interrogator mounted on the aft underfuselage of a tanker aircraft, for example, for interrogating and receiving a reply from a small microwave transponder mounted on the receiver aircraft near the aerial refueling receptacle. The angle of the received signal relative to the tanker is obtained from the angle sensing receiver portion of the microwave interrogator; whereas range is obtained from the phase of the returned modulation tone (i.e., a range tone) relative to that which was transmitted by the interrogator. The transponder sends back to the interrogator a signal which is shifted in frequency with respect to the transmitted signal and operates in an active mode with gain at long ranges and in a passive mode with no gain at shorter ranges to achieve extremely accurate guidance characteristics.”

Chisolm (1991, U.S. Pat. No. 4,990,921, Multi-mode microwave landing system, assigned to Sundstrand Data Control, Inc.) describes “a guidance system for landing an aircraft is described which uses a source of signals identifiable with the aircraft and a ground station which is linked to the aircraft. Specifically, the ground station includes a receiver which is connected to one or more pairs of antennas having a fixed, overlapping, directional sensitive pattern symmetically located relative to the center of the landing path, a receiver and a processor for measuring the relative sensitivity of the signals received at the antennas and for using the relative signal intensity to determine the location of the aircraft relative to the center of the landing path.”

The above inventions also address vehicle navigation issues relevant to the present invention. Fitzsimmons, et al. (1979) suggests means alternative from those in Eckstein (1999) for accomplishing a fueling rendezvous. Both Chislom (1991) and this inventor's pending “Aircraft Emergency Control System (U.S. Patent Application No. 60/324,605, non-provisional filing Sep. 26, 2002) address means for assuring safe landing in instances where a given refueling drone is released from the receiving aircraft for return to a ground base.

[Jet-Type Scavenge Pump]

Brown, et al. (1998, U.S. Pat. No. 5,806,560, Aircraft fuel transfer pump with auxiliary fuel line scavenge pump, assigned to J. C. Carter Company, Inc.) describes, ”an improved fuel transfer pump is provided for relatively high flow transfer of fuel from one aircraft to another during an inflight refueling procedure, wherein the fuel transfer pump includes a jet-type scavenge pump for evacuating residual fuel from a fuel line or manifold. The scavenge pump comprises a venturi element connected along a recirculation conduit through which a small fuel flow is diverted from the high pressure discharge side of the fuel transfer pump for return to the fuel tank. The recirculation fuel flow induces a vacuum in a suction throat of the venturi element, and this vacuum is coupled by a suction line to evacuate residual fuel from the fuel line or manifold to the fuel tank. A flow baffle is mounted along the recirculation conduit downstream from the venturi element to ensure flooding and priming of the scavenge pump.”

Brown, et al. (1998) suggests a means for optimizing fuel flow management within a given fueling drone.

The Current Invention

The benefits of the present invention in contrast with the prior art discussed above may best be understood in reference to the third and following drawings included in this application.

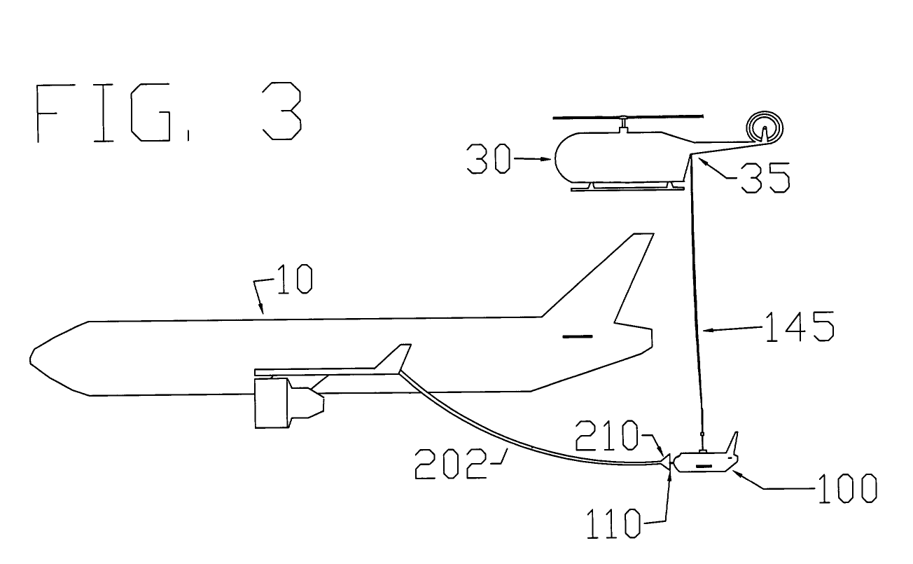

FIG. 3 depicts a tanker 10 providing fuel to a receiving aircraft, here depicted as helicopter 30, by means of a conduit 202 via drogue 210, similar in these aspects to the configuration depicted in FIG. 2. This FIG. 3 contrasts with the methods represented in the earlier drawings, however, in that the interface to said drogue 210 is via a probe 110 projected from the forward face of an intermediate fueling drone 100, so configured that fuel from tanker 10 is first captured by said fueling drone 100, thence flows via umbilical 145 as suspended from winch assembly 35, thereby providing fuel in flight to said helicopter 30.

As may be noted in reference to FIG. 3, the introduction of said drone 100 to the mid-air refueling repertoire improves that art in several particulars relevant to flight control and safety problems central to such operations.

In a first general instance, the problem of “formation flight” is simplified. Since the flight trajectory of receiving aircraft 30 is outside the ‘wake’ of tanker 10 (and similarly the trajectory of tanker 10 is outside the ‘wake’ of receiving aircraft 30), maintaining the two aircraft in fixed separation during the fueling operation is accomplished largely outside the envelope of such turbulences, drastically reducing the flight control complexities traditionally associated with mid-air refueling.

In a second general instance, the problem of “dynamic weight and balance” is mediated. In mid-air refueling operations as depicted, the weight of receiving aircraft 30 increases (and that of tanker 10 decreases) as fuel reaches it from tanker 10. To the extent that an aircraft's center of gravity changes from such a transfer, it is incumbent on the pilot to adjust accordingly the aircraft's flight attitude. However, such attitude adjustments are limited by the simultaneous requirement of assuring the continued seating of probe 110 with drogue 210. Using drone 100 separates the fuel transfer interface point from the respective payloads, allowing the aircraft pilots greater discretion in such flight attitude maneuvers without compromising the ‘probe and drogue’ seating requirement described above.

In another general instance, provisioning drone 100 with a capacity to separate from receiving aircraft 30 under controlled conditions serves both to mitigate fueling-related fire hazards and to bring other benefits.

While as mentioned above, the art of mid-air refueling includes technologies for controlling the chemistry of the fuel transfer environment in order to reduce the risk of fire, the probable locus of such ignition remains in the vicinity of the fuel transfer interface point, so that providing a given drone 100 with such “break away” ability is a fail-safe with respect to such risk.

Extending the conditions under which drone 100 can separate from its associated receiving aircraft 30 to include non-emergencies is particularly beneficial when the drone in embodiment includes controlled landing and as appropriate powered flight capabilities.

One scenario typifying such benefits is that of a receiving aircraft 30, in planning to reach a destination beyond the range attainable with its payload, expends fuel to reach tanker 10 at altitude, and by the means depicted first refuels so as to bring the destination within available range, and then releases drone 100. Said release thereby reduces the gross weight and further extends the flight range of aircraft 30, at the same time freeing drone 100 to return to ground for similar use by other aircraft.

In the specific instance where the receiving aircraft is a helicopter 30, the problem of rotor-probe proximity is eliminated. As stated earlier, helicopter operators in present practice typically are neither trained nor allowed to refuel in flight, other than for ‘special operations’, since under-rotor fueling probe configurations are so dangerous. Note in FIG. 2 that the close proximity of helicopter rotor 31 to its fuel probe 110 engenders potentially catastrophic risks of conflagration or similar flight disasters. Particularly in low humidity atmospheres, movement of rotor 31 may induce electrostatic charges imparting sparks in the vicinity of probe 110 and the fuel transfer interface point. Wake related turbulence and other factors also leave open the possibility of a rotor 31 physically striking and compromising the integrity of a given fuel conduit 202 or drogue 210. Because the refueling method depicted in FIG. 3 avoids the occasion and context of such risks, its use with airborne helicopters as a class makes their refueling safer, and in deployment provides a reasoned basis for including mid-air refueling in their standard training programs.

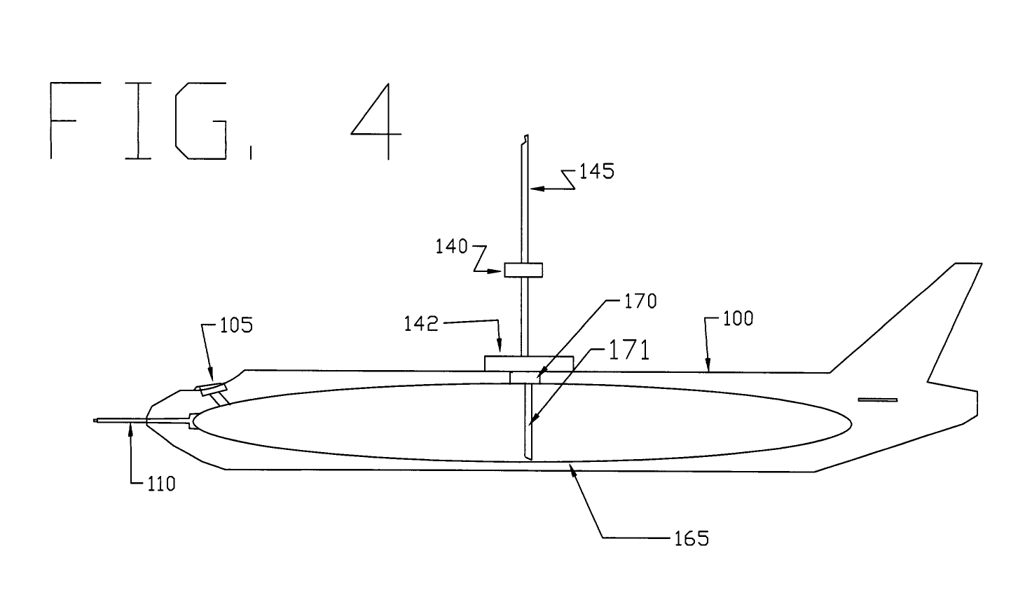

The features of fueling drone 100 as discussed above may be better understood in reference to FIG. 4, depicting said drone in cross section, wherein in the same vehicle 100 may be seen both a fueling probe 110 and a fueling receptacle 105, thereby assuring interface compatibility with all current methods for the capture of fuel from an airborne supplying tanker. Either probe 100 or receptacle 105 can deliver fuel to filter chamber 165, whence fuel can flow via uptake conduit 171 and dispensing assembly 170 to drone umbilical interface 142, and thereby via umbilical 145 to the receiving aircraft.

In functional terms, filter chamber 165 may be understood to serve as a resonator smoothing the flow of transiting fuel. In a preferred embodiment, chamber 165 is arranged with respect to drone 100 so as to assure a common center of gravity, whereby the flight attitude of drone 100 need not change with the amount of fuel on board. The functional roles of uptake conduit 171 and dispensing assembly 170 pertain to managing the fuel flow between drone 100 and the receiving aircraft, such that the specific positioned and operation of dispensing assembly 170 may depend on embodiment and fuel flow rate.

The functional role of umbilical interface 142 is to secure and support drone 100 with respect to umbilical 145 and the receiving aircraft to which it is connected. It is also an appropriate locale for the placement of local navigation and flight control support for the drone. Docking sensor assembly 140 is depicted on umbilical 145 in a position superior to drone umbilical interface 142, so as to allow monitoring of the docking of probe 110 with a drogue, or a boom with receptacle 105. Imaging data from sensor 140 may be augmented by additional sensors located at other sites (e.g. wingtips) on drone 100, aboard the receiving aircraft or the providing tanker. Said data may be computationally integrated through a Kalman Filter or similar algorithm driving the drone's control system, thereby assuring reliable docking and fuel exchange with minimal operator intervention.

The functional roles of umbilical interface 142 and sensor assembly 140 may merge in specific embodiments; either component may prove an appropriate umbilical separation point in support of the controlled separation scenarios discussed above.

Specific embodiments of drone 100 may reflect attributes of particular receiving aircraft. For example, in that helicopters tend to have relatively narrow bodies, requirements for corresponding drones would include a limited wingspan, favoring canard, swept or multiple wing designs.

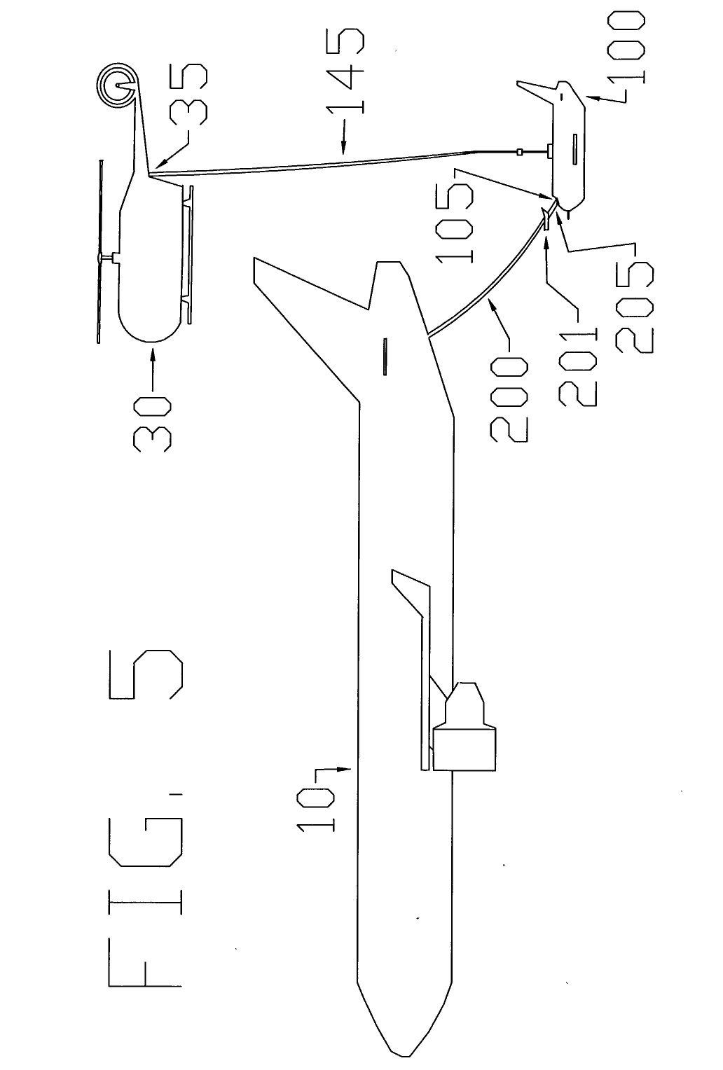

The generality of the solution provided by the introduction of drone 100 into the mid-air refueling repertoire is further exemplified in reference to FIG. 5, where is depicted a helicopter 30 receiving fuel from a tanker 10 via its fueling boom 200 and nozzle 205, as controlled by ruddervator 201 in the manner described for FIG. 1, here establishing a fuel transfer interface point by means of receptacle 105 of drone 100, and thence via umbilical 145 and winch assembly 35 to said helicopter 30. As discussed above, a specific innovation of this invention relates to the means here described, allowing helicopters to receive otherwise unavailable fuel from tankers equipped with a boom assembly but lacking drogue support.

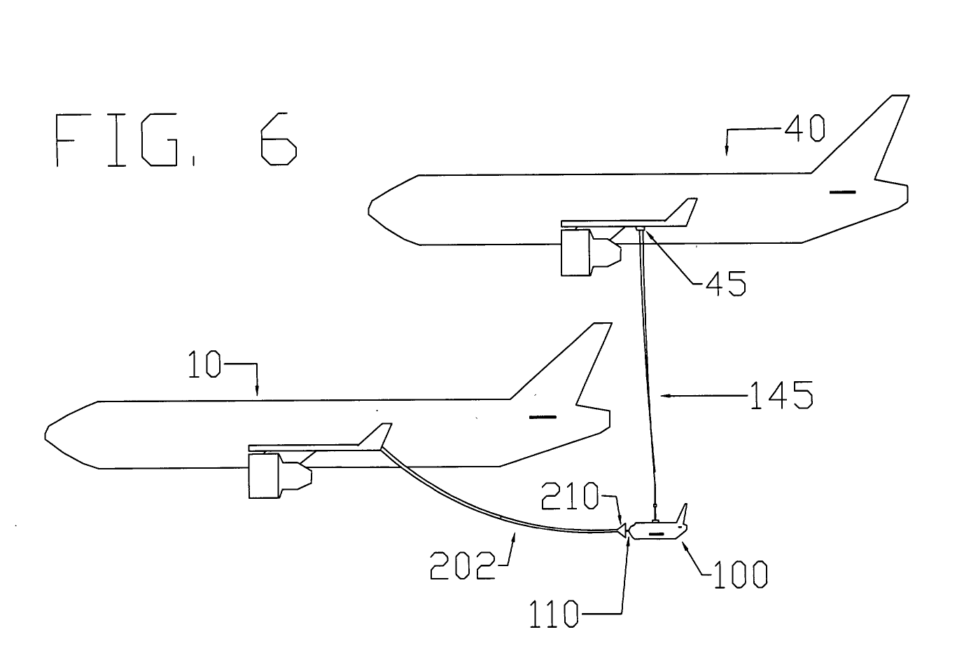

Equally compatible with contemporary and existing mid-air refueling systems is the configuration depicted in FIG. 6, where, as in FIG. 3, a tanker 10 by means of a conduit 202 and a drogue 210 presents fuel to probe 110 of a drone 100. Said fuel then flows via umbilical 145 to a winch assembly 45 located on an inferior wing surface of jet aircraft 40. Said configuration exemplifies a means consistent with the invention for implementing the range extension scenario discussed for FIG. 3. More particularly, this embodiment shows for the first time a practical way to bring mid-air refueling to commercial aviation use. Consider the case of jet 40 as a cargo liner over the mid-West, so heavily laden that the bulk of its fuel has been used to reach a flight level above 30,000 feet. Since providing a reliable and safe means for again filling the tanks of such an aircraft allows it to reach a vast range of Pacific Rim and Eurasian destinations, this example shows means to extend the range and productive life of today's existing commercial aircraft fleet. In the ‘break away’ scenario discussed above, refueling might be viewed as a “one shot” process, whereby the entire refueling assembly is attached to jet 40 only through completion of the refueling process. In a preferred embodiment, as the depicted refueling operation ends and drone 100 separates from drogue 210 of tanker 10, winch assembly 45 first retrieves umbilical 145 to anchor drone 100, and winch and drone as a unit then separate from jet 40 for return to ground and later use by another receiving aircraft. The airfoil characteristics of the wing releasing winch assembly 45 can, following separation, match those of an aircraft not so equipped, thereby allowing normal operations for the (extended) remaining duration of a given jet 40's flight.

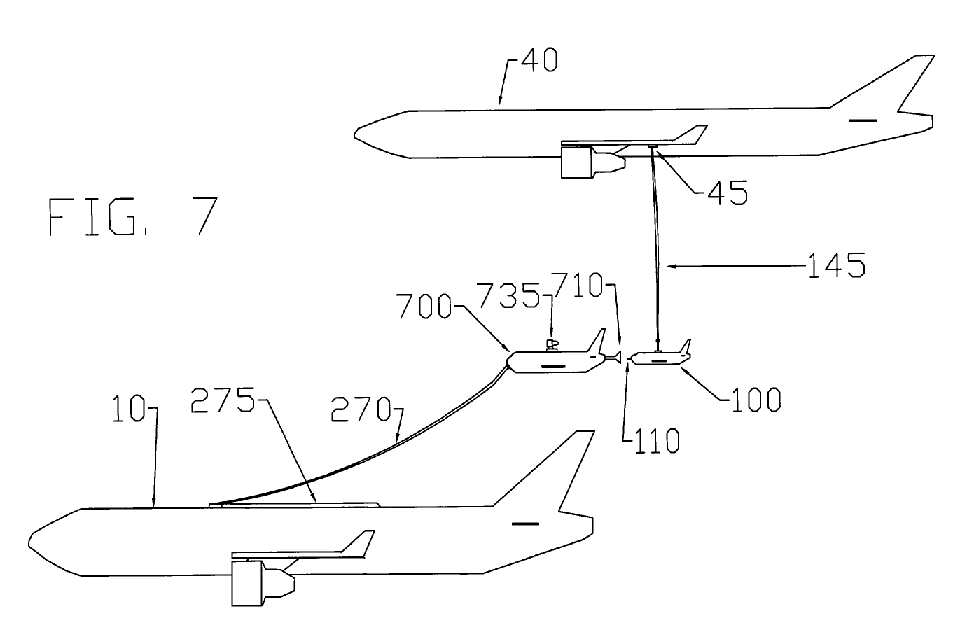

While looking beyond configurations fully compatible with existing mid-air refueling methods is necessarily speculative, FIG. 7 depicts such an embodiment, wherein a tanker 10 deploys from docking platform 275 an umbilical 270 to an attached fuel-providing drone 700. Said drone 700 is equipped with a thrust capability 735 and tailing drogue 710. Thrust capability 735, provided either in the form of a ram jet stream from tanker 10 or through the inclusion of a separate engine, is used by drone 700 to maintain an altitude superior to tanker 10, thereby allowing increased separation between tanker 10 and a receiving aircraft 40. Fuel reaches said aircraft 40 from receiving drone 100 in the manner described in FIG. 6. The deployment and recapture of drone 700 with respect to tanker 10 uses docking platform 275. Said platform 275 supports drone 700 in a manner similar to that used presently to transport the Space Shuttle.

The drawings and discussions provided with this application include descriptions understandable to practitioners of the art wherefrom may be drawn conclusions about the contribution of this invention to the field of interests, as identified below:

I claim:

1. A method and system for delivering fuel to flying helicopter and fixed winged aircraft that is both safer than and compatible with presently used airborne fueling practices, through the use of one or more additional air vehicles, herein described as refueling drones or drones, as towed by deploying aircraft, either the source or recipient of fuel, configured to enhance the safety and reliability of mid-air refueling,
wherein the deployment tether acts as an umbilical in providing a path for fuel transfer and data lines, and contemporary guidance technology may be used to control the drone's flight;
whereby compatibility with all mid-air fuel dispensing equipment in present use is assured by configuring instances of recipient aircraft-tethered drone fuselages with receptacles for accommodating a tanker-controlled fuel dispensing boom, a forward-facing recipient-controlled fuel capture probe for accommodating fuel dispensing drogues, or both in some combination, and instances of mid-air fuel dispensing drones to include fueling drones of complementary configuration for deployment from airborne fuel tanker;
wherein said guidance technology may include real-time inertial and positional sensor data for the drone, the tanker and the recipient aircraft, as exchanged among the aircraft, and said data may be computationally integrated through a Kalman Filter or similar algorithm driving the drone's control system, to assure reliable docking and fuel exchange with minimal operator intervention;
whereby the use of said tethered drones in the mid-air refueling process allows a substantial increase in the separation between tanker and receiving aircraft, thereby lowering the risk of mid-air collision;
whereby to the extent that such separation is vertical or lateral with respect to the common line of flight, there is a corresponding reduced risk of the tanker's wake disturbing the flight path of the receiving aircraft;
whereby the drone acts much as does a filter tank in ground based fueling systems, such that splash containment, flow synchronization and the like are managed within its fuel chamber;
whereby the drone is isolated from the usual complexities attributed to maintaining a refueling-specific flight attitude in face of the changing vehicle mass conditions associated with fuel intake, since such fuel mass flows to the receiving aircraft via the umbilical, and in a fueling fire or similar emergency, the entire umbilical assembly can be released, protecting the deploying aircraft.

2. Any embodiment corresponding to claim 1, wherein a given drone may have locally available thrust capability to improve flight control and orientation during fueling and other operations.

3. Any embodiment corresponding to claim 1, particularly as applied to military use, wherein communications associated with mid-air refueling operations quiet in the radio spectrum are realized by constraining the energy emitting portions of the position sensing and data exchange systems to the optical spectrum.
